(19) United States
(12) Patent Application Publication
(10) Pub. No.: US 2005/0271832 A1
(43) Pub. Date: Dec. 8, 2005

(54) Manufacturing method and manufacturing system of liquid crystal display, liquid crystal display, and electronic apparatus

(75) Inventor: Tamotsu Goto, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/101,419

(22) Filed: Apr. 8, 2005

(30) Foreign Application Priority Data
Apr. 30, 2004 (JP) 2004-135946

(51) Int. Cl. C09K 19/00

(52) U.S. Cl. 428/1.1

(57) ABSTRACT

Aspects of the invention can provide a manufacturing method and a manufacturing device of a liquid crystal display for forming an even alignment layer by changing a coating quantity of an alignment layer material for each preset area on a substrate. In the method, a substrate conveyed by a belt conveyor BC driven by a drive based on a signal from a control, for example, a substrate on which a segment electrode is formed, can be cleaned at a cleaner 4. Next, an alignment layer material of different viscosity can be coated on each preset area at a discharger. Next, temporary drying of the alignment layer material coated on the substrate is carried out at the dryer, the substrate can be baked at an oven, and the alignment layer is formed. Then, the alignment layer is subjected to a rubbing process at a rubber.

### BACKGROUND

Aspects of the invention can relate to a manufacturing method of a liquid display device constituted by holding a liquid crystal layer between a pair of substrates, its manufacturing device, a liquid crystal display, and electronic equipment.

A liquid crystal display holds a liquid crystal layer made up of liquid crystal composition between a pair of substrates with formation of electrodes thereon, impresses a voltage from electrodes of each substrate on the liquid crystal composition, and performs displaying. In the liquid crystal display, an alignment layer is used to orient liquid crystal molecules in a preset direction to make an even display when a voltage is impressed.

As related art methods of forming this alignment layer on the substrate, there are available printing methods, such as a flexo printing method and an offset printing method. For example, according to the flexo printing method, after ink including the alignment layer material is transcribed and coated to the substrate by printing, heating at a preset temperature evaporates a solvent component and the alignment layer is formed by subsequent baking at a preset temperature.

It should be noted that in Published Unexamined Patent No. Hei 9-105937, for example, there is disclosed a method of forming an alignment layer of a liquid crystal display element so as to coat the alignment layer material evenly while enhancing a rate of utilization of the alignment layer material. In this method of forming the alignment layer of a liquid crystal element, the oriention layer is coated evenly on the substrate by carrying out a plurality of times a process of spraying and coating an alignment layer forming solution on the transparent substrate with electrodes formed thereon by using an inkjet nozzle.

### SUMMARY

Incidentally, ink including the alignment layer materially which is typically used in printing is adjusted in consideration of printability such that its viscosity is on the level of 40-60 mPa·s. Consequently, there can be a problem in which because of high viscosity of the ink, uneven print tends to occur when transcribing and coating to the substrate, so that inferior display tends to generate.

On the other hand, when using the inkjet nozzle, since the same viscosity as the printing method makes it impossible to discharge the alignment layer material through the inkjet nozzle, the viscosity of the ink including the alignment layer material is adjusted to under 10 mPa·s by increasing the solvent component. Hence, to form an alignment layer having the same thickness as an alignment layer formed by the printing method, although it is necessary to coat more ink on the substrate, contrary to a case of transcribing and coating on the substrate, it is possible to prevent generation of the uneven print.

However, when an alignment layer material of low viscosity is coated on the substrate, even in case of coating evenly on the substrate, at the time of evaporating the solvent in the drying process, a thickness of the alignment layer to be formed on the periphery on the substrate becomes thick relative to a thickness of the alignment layer to be formed on the central area on the substrate. Namely, it is empirically known that there occurs in the drying process a lowering of a liquid level as the alignment layer material dries up first from the periphery of the substrate to permit the ink of the central area to flow into the periphery, so that the thickness of the alignment layer formed on the periphery becomes thicker than the thickness of the alignment layer formed on the central area. Consequently, by coating the alignment layer material evenly, the thickness of the alignment layer formed becomes conversely uneven, thus creating a problem of generating inferior display.

Aspects of the invention can provide a manufacturing method of a liquid crystal display, which is capable of forming an even alignment layer on the substrate by means of coating an alignment layer material of differing viscosity per preset area on the substrate, as well as a manufacturing device of a liquid crystal display, a liquid crystal display manufactured by the manufacturing method of the liquid crystal display, and electronic equipment mounted with a manufactured liquid crystal display.

The manufacturing method of the liquid crystal display is a manufacturing method of a liquid crystal display having a liquid crystal layer held between a pair of substrates, and can include an alignment layer material discharge process discharging a liquid droplet including the alignment layer material onto the substrates, and a drying process of drying the alignment layer coated in the alignment layer material discharge process and forming the alignment layer. The alignment layer material of differing viscosity is coated per preset area on the substrate by using a liquid droplet discharge device in the alignment layer material discharge process.

According to the exemplary manufacturing method of the liquid crystal display, by discharging a liquid droplet including the alignment layer material to each preset area, the alignment layer material of differing viscosity is coated per preset area. Consequently, when the alignment layer material is coated evenly on the substrate, by coating an alignment layer material of higher viscosity than other portions on a portion of the alignment layer whose thickness becomes thick, it is possible to prevent the alignment layer material from flowing in from other portions based on the lowering of the liquid level and to form an alignment layer of even thickness. As a result, generation of inferior display can be properly and easily reduced.

Further, the manufacturing method of the liquid crystal display can include dividing the preset area on the substrate onto which to discharge the liquid droplet including the alignment layer material into a periphery and a central area which is surrounded by the periphery in the alignment layer material discharge process. Consequently, the alignment layer material of the higher viscosity than the alignment layer material coated on the central area is coated, on the periphery.

According to the manufacturing method of the liquid crystal display, the preset area on the substrate can be divided into the periphery and the central area, wherein the alignment layer material of the higher viscosity than an alignment layer material coated on the central area is coated on the periphery. Namely, in case of coating the alignment layer material evenly on the substrate, the alignment layer material of high viscosity is coated on the periphery whose layer thickness is empricially known to become thick relative to the central area. Consequently, it is possible to reduce inferior display by decreasing the lowering of the liquid level of the periphery, preventing the alignment layer material of the central area from flowing into the periphery, and forming the alignment layer of even thickness.

Further, an exemplary manufacturing device of the liquid crystal display according to the present invention which is the manufacturing device of the liquid crystal display having a liquid crystal layer held between a pair of substrates, can include a liquid droplet discharge device discharging a liquid droplet including the alignment layer material to be coated on the substrate, and a dryer drying the alignment layer material coated on the substrate by the liquid droplet discharge device and forming the alignment layer. The alignment layer material of the differing viscosity is coated per preset area on the substrate by discharging the liquid droplet per preset area on the substrate including the alignment layer material through the liquid droplet discharge device.

According to the manufacturing device of this liquid crystal display, an alignment layer of differing viscosity is coated per preset area on the substrate. Consequently, when the alignment layer material is coated evenly on the substrate, by coating an alignment layer material of higher viscosity than other portions on a portion of the alignment layer whose thickness becomes thick, it is possible to prevent or reduce the alignment layer material from flowing in from other portions based on the lowering of the liquid level and to form an alignment layer of even thickness. As a result, generation of inferior display can be properly and easily reduced.

Further, the manufacturing device of the liquid crystal display can include coating on the periphery the alignment layer material of the higher viscosity than the alignment layer material coated on the central area in the liquid droplet discharge device, by dividing the preset area on the substrate onto which to discharge the liquid droplet including the alignment layer material into the periphery and the central area which is surrounded by the periphery. According to the manufacturing device of the liquid crystal display, the preset area on the substrate can be divided into the periphery and the central area, wherein the alignment layer material of the higher viscosity than the alignment layer material coated on the central area is coated on the periphery, so that it is possible to reduce the lowering of the liquid level due to drying and to form easily an alignment layer of even thickness, thus properly reducing inferior display.

Further, the liquid crystal display according to the invention can include being manufactured by the manufacturing method of the liquid crystal display of the present invention. According to this liquid crystal display, because it is manufactured according to the manufacturing method of the liquid crystal display according to the present invention, inferior display can be properly decreased.

Further, electronic equipment according to the invention can include being mounted with the liquid crystal display of the present invention. According to this electronic equipment, since it is mounted with the liquid crystal display which properly reduced inferior display, yield of the electronic equipment can be improved, while reducing manufacturing cost of the electronic equipment.

### BRIEF DESCRIPTION OF THE DRAWINGS

The invention will be described with reference to the accompanying drawings, wherein like numerals reference like elements, and wherein:

FIG. 1 is a diagram showing an example of a liquid crystal display production line according to an exemplary embodiment;

FIG. 2 is a schematic diagram of an inkjet type discharger according to an exemplary embodiment;

FIG. 3 is a schematic diagram of an inkjet type discharger according to an exemplary embodiment;

FIG. 4 is a schematic diagram of a section of a liquid crystal display according to an exemplary embodiment;

FIG. 5 is a flowchart of a manufacturing method of a liquid crystal display according to an exemplary embodiment;

FIG. 6 is a diagram of an example of an alignment layer material coated area according to an exemplary embodiment; and

FIGS. 7A-7C are perspective views of electronic equipment mounted with a liquid crystal display according to an exemplary embodiment.

### DETAILED DESCRIPTION OF EMBODIMENTS

A manufacturing device of a liquid crystal display according to an exemplary embodiment of the invention will be described as follows with reference to the drawings.

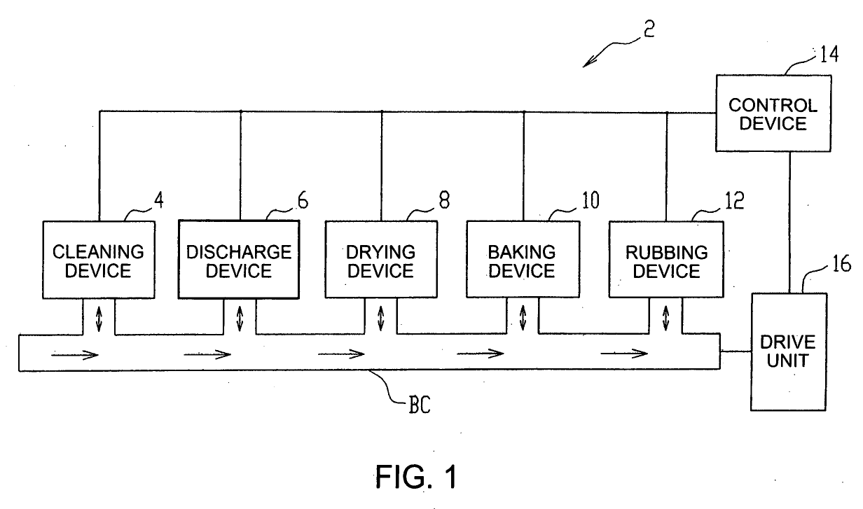

FIG. 1 is a diagram showing an example of configuration of a manufacturing device (liquid crystal display production line) of a liquid crystal display according to an embodiment of the present invention. As shown in FIG. 1, a liquid crystal display production line 2 is constituted by a cleaner 4, a discharger (liquid droplet discharger) 6, a dryer 8, an oven 10, and a rubber 12, a belt conveyor BC linking each device, a drive 16 driving the belt conveyor BC, and a control 14 controlling the entire liquid crystal display production line 2, which are respectively used in each process. Further, the cleaner 4, the discharger 6, the dryer 8, the oven 10, and the rubber 12 are arranged in a single line along the belt conveyor BC at a preset spacing.

The control 14 is linked to the cleaner 4, the discharger 6, the dryer 8, the oven 10, the rubber 12, and the drive 16. The drive 16 drives the belt conveyor BC based on control signals from the control 14, conveying a substrate of the liquid crystal display (hereinafter referred to simply as the substrate) to the cleaner 4, the discharger 6, the dryer 8, the oven 10, and the rubber 12. A process of cleaning the substrate is performed in the cleaner 4, a process of coating an alignment layer material on the substrate, that is, a process of discharging liquid droplets including the alignment layer material onto the substrate, is performed in the discharger 6, and a process of temporarily drying the alignment layer material is performed in the dryer 8.

Further, in the oven 10, there is performed a process of baking the dried alignment layer material, while a process of rubbing the alignment layer is performed in the rubber 12. It should be noted that the temporary drying performed in the dryer 8 and the baking process performed in the oven 10 correspond to the process performed as the drying process.

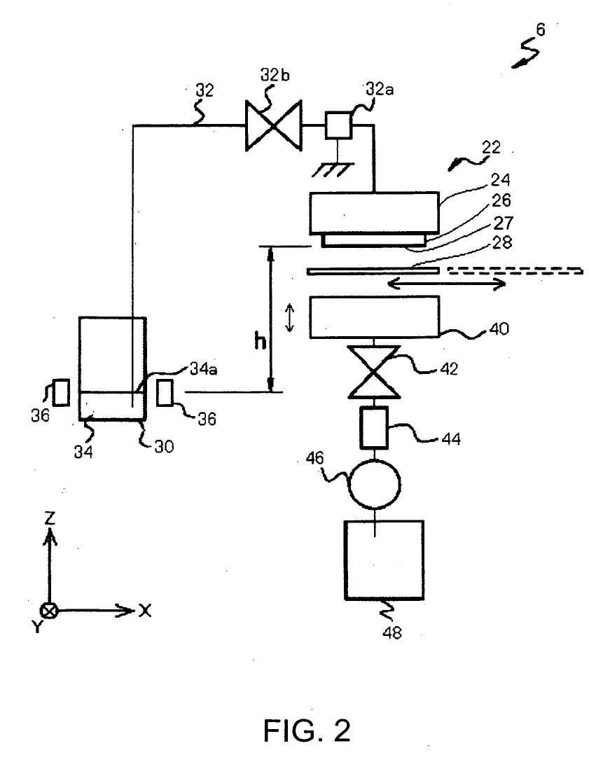

FIG. 2 is a schematic diagram showing a configuration of the discharger 6 of an inkjet type used as a liquid droplet discharger according to an exemplary embodiment of the invention. This discharger 6 is provided with an inkjet head 22 discharging ink onto the substrate. This inkjet head 22 is provided with a head body 24 and a nozzle formation surface 26 in which multiple nozzles discharging ink are formed. From the nozzles of this nozzle formation surface 26 are discharged ink, that is, ink including an alignment layer material (hereinafter referred to simply as the alignment layer material) for forming the alignment layer on the substrate.

Further, the discharge device 6 can be provided with a table 28 on which to place the substrate. This table 28 is movably set up in a preset direction, for example, an x-axis direction, a y-axis direction, and a z-axis direction. Further, the table 28 places the substrate conveyed by the belt conveyor BC on the table 28 by moving in a direction along the x-axis as shown by arrow in the diagram and takes it inside the discharger 6.

Further, there is linked to the inkjet head 22 a tank 30 holding the alignment layer material which is the ink to be discharged from the nozzles formed on the nozzle formation surface 26. Namley, the tank 30 and the inkjet head 22 are linked by an ink conveying tube 32 which carries the ink. Further, this ink conveying tube 32 is provided with an earth coupling 32a of an ink flow path part and a bubble eliminating valve 32b of a head part to prevent inside the flow path of the ink conveying tube 32 from charging.

This bubble eliminating valve 32b of the head part is used when sucking the ink inside the inkjet head 22 by a suction cap 40 to be explained later. Namely, when sucking the ink inside the inkjet head 22 through the suction cap 40, this bubble eliminating valve 32b of the head part is put into the closed state to stop the ink from flowing in from the tank 30 side. And, when suction is carried out by the suction cap 40, the flow rate of the ink being sucked increases, thus quickly discharging bubbles inside the inkjet head 22.

Furthermore, the suction device 6 can be provided with a liquid level control sensor 36 for controlling the amount of the ink held in the tank 30, that is, a height of the liquid level 34a of the alignment layer material held in the tank 30. This liquid level control sensor 36 performs control such as to keep a difference h (hereinafter referred to as the “liquid top value”) between a tip 27 of the nozzle formation surface 26, which is provided in the inkjet head 22, and the height of the liquid level 34a within a preset range. By controlling the height of the liquid level 34a, the ink 34 in the tank 30 is sent to the inkjet head 22 by pressure inside the preset range. And by sending the ink 34 by the pressure within the preset range, it is possible to discharge the ink 34 stably from the inkjet head 22.

Further, there is arranged the suction cap 40 sucking the ink in the nozzle of the inkejet head 22, at a fixed distance apart, opposite to the nozzle formation surface 26 of the inkjet head 22. This suction cap 40 is movably constructed in a direction along the z-axis shown by arrow in FIG. 2. It is constructed such as to adhere closely to the nozzle formation surface 26 in a manner of surrounding a plurality of nozzles formed on the nozzle formation surface 26, thus shutting the nozzles from the outside air by forming a hermetically sealed space therebetween and the nozzle formation surface 26.

Further, suction of the ink in the nozzles of the inkjet head 22 through the suction cap 40 is carried out when the inkjet head 22 is not discharging the ink 34, for example, when the inkjet head 22 retreats in a retreat position and the like with the table 28 retreating to a position shown in broken lines. Moreover, below the suction cap 40, there is set up a flow path, and on this flow route there are set up a suction pump 46 consisting of a suction valve 42, a suction detection sensor 44 detecting suction abnormalities, a tube pump and the like. Further, the ink 34 conveyed through the flow path is held in a waste fluid tank 48.

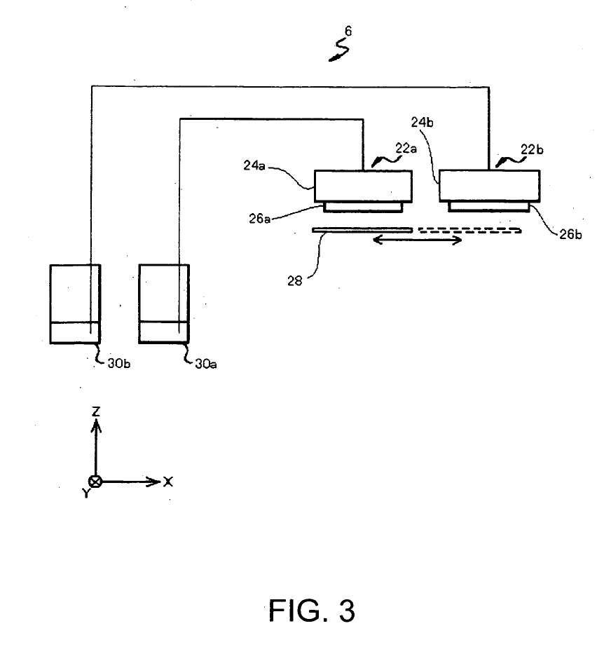

In th discharger 6, as shown in FIG. 3, there are provided two each of the inkjet heads 22 and the tanks 30 which were shown in FIG. 2 above, so as to coat the alignment layer material of differing viscosity per preset area on the substrate. For example, there are provided a first tank 30a holding a alignment layer material of high viscosity and a first inkejet head 22a discharging the alignment layer material held in the first tank 30a as well as a second tank 30b holding an alignment layer material of lower viscosity than the alignment layer material held in the first tank 30a and a second inkjet head 22b discharging the alignment layer material held in the second tank 30b.

The first inkjet head 22a is coupled to the first tank 30a which holds the alignment layer material to be discharged from nozzles (first nozzles) formed on the nozzle formation surface 26a of the head body 24a of this first inkjet head 22a.

Further, the second inkjet head 22b is coupled to the second tank 30b which holds the alignment layer material to be discharged from nozzles (second nozzles) formed on the nozzle formation surface 26b of the head body 24b of this second inkjet head 22b.

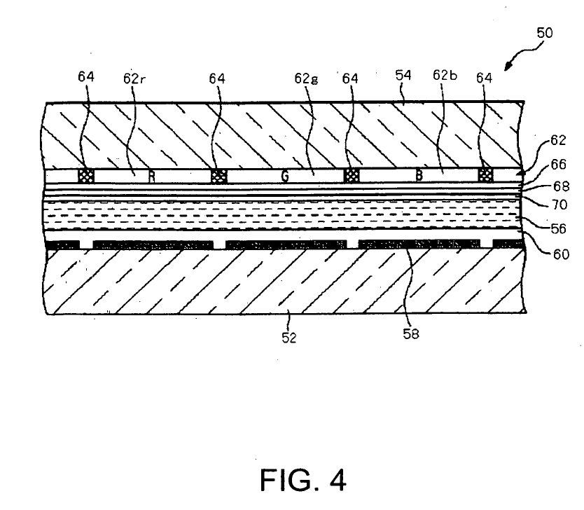

Now, the liquid crystal display will be described. FIG. 4 is a diagram schematically showing a sectional view of the liquid crystal display. As shown in FIG. 4, in a liquid crystal display 50, a substrate 52 of a rectangular planar shape made up of glass, plastic and the like and a substrate 54 are arranged opposite to each other through a sealant and a space (not illustrated), while a liquid crystal 56 constituted by an STN (Super Twisted Nematic) liquid crystal and the like is held between the substrate 52 and the substrate 54.

Between the substrate 52 and the substrate 56, there are formed a plurality of segment electrodes 58 and an alignment layer 60 in order from the substrate 52 side. The segment electrodes 58 are, as shown in FIG. 4, formed in a stripe shape and formed of a transparent conductive layer such as Indium Tin Oxide (hereinafter abbreviated as “ITO”). Further, the alignment layer 60 is formed of a polyimide resin and the like.

Further, between the substrate 54 and the liquid crystal 46, there are formed a color filter 62, an overcoat layer 66, a common eloectrode 68, and an alignment layer 70 in order from the substrate 54 side. The color filter 62 consists of each pigment layer, 62r, 62g, and 62b of red (R)), green (G), and blue (B).

Among the each pigment layer, 62r, 62g, and 62b (boundaries), constituting the color filter 62, there is formed a black matrix 64 made up of a resin black and a metal such as chromium (Cr) with a low reflection factor of light. It should be noted that the each pigment layer of 62r, 62g, and 62b constituting the color filter 62, is arranged opposite to the segment electrodes 58 formed on the substrate 52.

Further, while the overcoat layer 66 levels out height differences among each pigment layer of 62r, 62g, and 62b, at the same time, it, being formed of an inorganic layer such as an acrylic resin, a polyimide resin, and a silicon oxide layer, protects the surface of each pigment layer. Further, the common electrode 68 is formed of a transparent electrode layer, such as ITO, and formed in a stripe shape at a position intersecting at right angles to the segment electrode 58 which is formed on the substrate 52.

Further, the alignment layer 70 is formed of the polyimide resin and the like. Consequently, description will be made as follows regarding formation of the alignment layer with respect to the substrate 52 with the segment electrode 58 formed thereon, or the substrate 54 on which the color filter 62, the black matrix 64, the overcoat layer 66, and the common electrode 68 are formed.

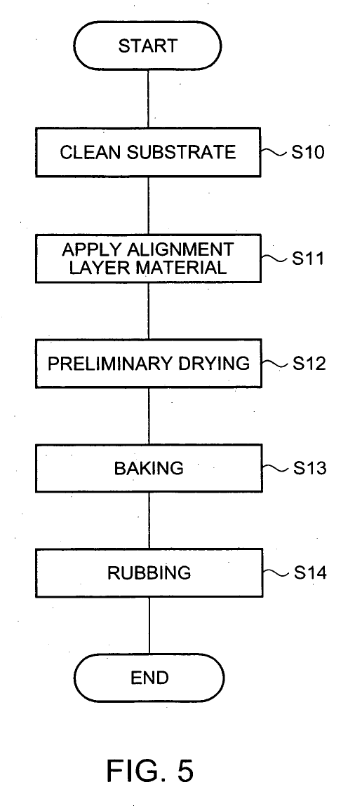

Next, a manufacturing method of the liquid crystal display in the liquid crystal display production line according to an exemplary embodiment will be described with reference to a flowchart in FIG. 5.

First, a substrate forming an alignment layer is cleaned (step S10). For example, a substrate 52 on which segment electrodes 58 are formed is conveyed via a belt conveyor BC to a cleaner 2. After the substrate 52 conveyed by the belt conveyor BC is taken in to the cleaner 2, it is subjected to cleaning by using an alkaline detergent, pure water and the like. Then a drying treatment is carried out at a preset temperature and time, for example, at 80-90° C. for 5-10 minutes. It should be noted that the substrate 52 treated with cleaning and drying is conveyed by the belt conveyor BC to the discharger 6.

Next, the alignment layer material is coated (step S11) on the substrate which was cleaned in step S10. Namely, first, the substrate conveyed by the belt conveyor BC to the discharger 6, for example, the substrate 52, is placed on the table 28 and taken into the discharger 6. In the discharger 6, the alignment layer material held in the tank 30a through the first nozzles of the nozzle formation surface 26a and the alignment layer material held in the tank 30b through the second nozzle of the nozzle formation surface 26b are respectively discharged to preset areas and coated on the substrate 52. Processing to coat the alignment layer material on the substrate is described as follows with reference to the drawing.

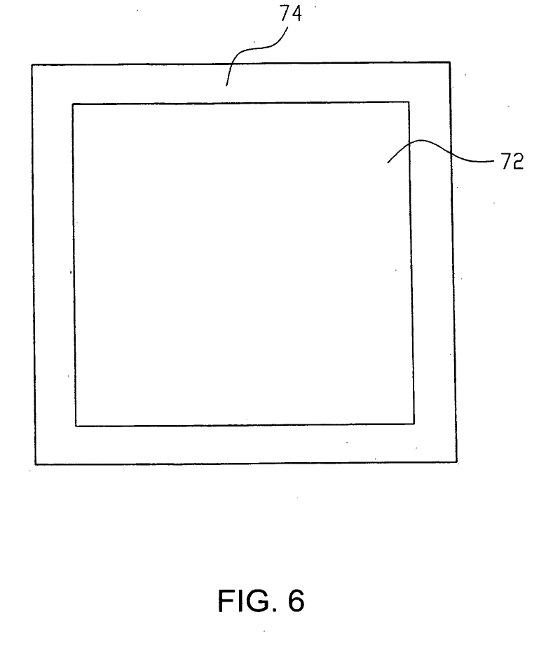

FIG. 6 is a diagram to explain the alignment layer material coating area on the substrate according to an embodiment of the present invention. The coating area of the alignment layer material on the substrate is, as shown in FIG. 6, divided into a central part (central area) 72 and a peripheral part (peripheral area) 74.

At this time, in FIG. 6, a surrounding area of 2 mm wide in the alignment layer material coating area on the substrate is set as the peripheral part, and an area surrounded by this peripheral part is set as the central part 72. Namely, in case of coating evenly over the entire alignment layer material coating area including the central part 72 and the peripheral part 74, it is empirically known that the thickness of the alignment layer formed on the peripheral part 74 becomes thicker than the thickness of the alignment layer formed on the central part 72.

On the other hand, even in case of forming the alignment layer under the same process and the same condition, there is an area of thicker thickness of the alignment layer than the thickness of the alignment layer formed on the central part due to the type of the alignment layer, solvent composition, and the ratio of the solvent composition and there is a divergent difference of thickness between the thickness of the alignment layer formed on the central part and the thickness of the alignment layer formed on the peripheral part.

Consequently, as mentioned above, an area which is empirically known that its thickness is thicker than the thickness of the alignment layer formed on the central part is set as the peripheral part.

In the discharger 6, by discharging the alignment layer material of high viscosity through the first nozzles of the nozzle formation surface 26a to the peripheral part 74 and the alignment layer material of low viscosity through the second nozzles of of the nozzle formation surface 26b to the central part 72, alignment layer materials of differing viscosity are coated on the central part 72 and the peripheral part 74. For example, with respect to the peripheral part 74, the alignment layer material having a viscosity of 10 mPa·s is coated, while the alignment layer material having a viscosity of 6 mPa·s is coated with respect to the central part 72.

A substrate with alignment layer materials of differing viscosity coated on the central part 72 and the peripheral part 74, for example, the substrate 52, is maintained at the discharger 6 in a state of horizontality, for example, to be left for one minute, and leveling is performed. Thereafter, it is transferred from the table 28 to the belt conveyor BC and conveyed to the dryer 8 by the belt conveyor BC.

Next, there is performed a process to dry temporarily the alignment layer material coated on the substrate (step S12). Namely, a substrate conveyed by the belt conveyor BC to the dryer 8, for example, the substrate 52, is taken into the dryer 8, and, for example, temporarily dried at 60-100° C. It should be noted that the substrate 52 with the coated alignment layer material temporarily dried is transferred to the belt conveyor BC and conveyed to the oven 10 by the belt conveyor BC.

Next, there is performed a process to bake the temporarily dried alignment layer material (step S113). Namely, the substrate taken into the oven 10, for example, the substrate 52, is taken into the oven 10, and, for example, baked at 180-250° C. It should be noted that the substrate 52 on which there is formed the coated alignment layer material subjected to baking (for example, an alignment layer 60, refer to FIG. 3) is transferred to the belt conveyor BC and conveyed to the rubber 12 by the belt conveyor BC.

Next, there is performed a process to rub the alignment layer material 60 formed on the substrate (step S114). Namely, the substrate conveyed by the belt conveyor BC to the rubber 12, for example, the substrate 52, is taken into the rubber 12, and, for example, the rubbing process is carried out by rubbing the alignment layer formed on the substrate 52 by using a cloth.

It should be noted that after the rubbing process is applied to the alignment layer 60, the substrate 52 is transferred to the belt conveyor BC and held in an un-illustrated substrate holding cassette and the like by the belt conveyor BC.

At this point, the substrate 52 held in the un-illustrated substrate holding cassette and the like is glued to the substrate 54, on which there are formed the color filter 62, the black matrix 64, the overcoat layer 66, the common electrode 68, and the alignment layer in an un-illustrated assembled device. And as liquid crystals are injected in between the substrate 52 and the substrate 54, a liquid crystal display 50 shown in FIG. 4 is manufactured.

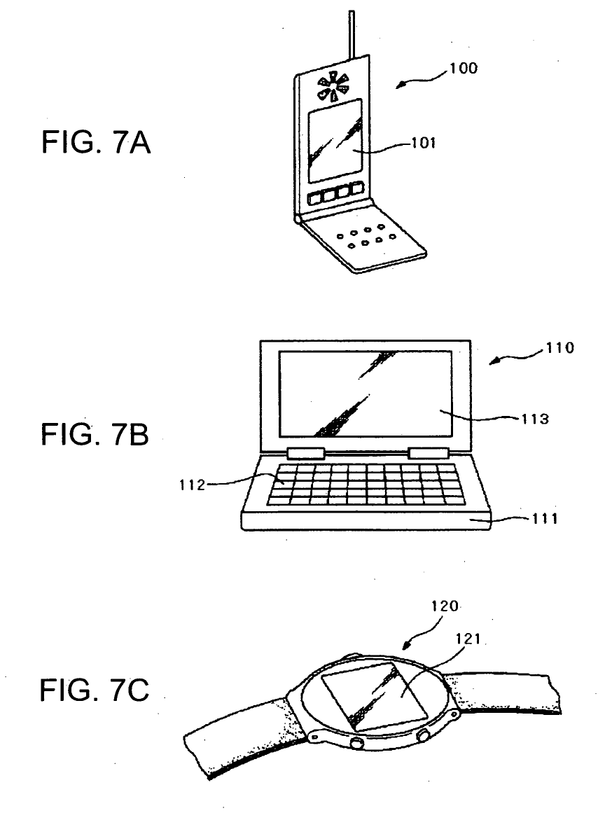

Next, electronic equipment mounted with a liquid crystal display manufactured in accordance with a manufacturing method of the liquid crystal display according to an embodiment of the present invention will be described. FIG. 7 is a perspective view of an example of electronic equipment mounted with a liquid crystal display manufactured in accordance with a manufacturing method of the liquid crystal display according to an exemplary embodiment of the invention.

FIG. 7A is a diagram showing an example of a mobile phone mounted with a liquid crystal display. As shown in FIG. 7A, as a display screen of a mobile phone 100, there is mounted a liquid crystal display 101 manufactured in accordance with a manufacturing method of the liquid crystal display according to an embodiment of the present invention. Further, FIG. 7B is a diagram showing an example of a portable information processing device (for example, a portable word processor, a portable personal computer and the like) mounted with a liquid crystal device.

As shown in FIG. 7B, an information processing device 110 is equipped with an information processing body 111, an input section 112 composed of a keyboard and the like, and a liquid crystal display 113 manufactured in accordance with a manufacturing method of the liquid crystal display according to an embodiment of the present invention.

Further, FIG. 7C is a diagram showing an example of a watch mounted with a liquid crystal display. As shown in FIG. 7C, as a display screen of a watch 120, there is mounted a liquid crystal display 121 manufactured in accordance with a manufacturing method of the liquid crystal display according to an embodiment of the present invention.

In accordance with a manufacturing device of the liquid crystal display according to an embodiment of the present invention, the alignment layer material coated area on the substrate is divided into the central part and the peripheral part, while the viscosity of the alignment layer material is changed depending on the central part and the peripheral part.

Namely, since the alignment layer material of higher viscosity than the viscosity of the alignment layer material coated on the central part is coated on the peripheral part, the lowering of the liquid level on the peripheral part in the drying process is reduced, thus making it possible to prevent the alignment layer material from flowing from the central part to the peripheral part. Consequently, it is possible to form an even alignment layer on the substrate and to reduce generation of inferior display.

Further, in accordance with a manufacturing method of the liquid crystal display according to an exemplary embodiment of the invention, the alignment layer material coated area on the substrate is divided into the central part and the peripheral part. Since the alignment layer material of higher viscosity than the viscosity of the alignment layer material coated on the central part is coated on the peripheral part, the lowering of the liquid level on the peripheral part in the drying process is reduced, thus making it possible to prevent the alignment layer material from flowing from the central part to the peripheral part. Consequently, even in case of using the discharger, it is possible to form an even alignment layer on the substrate and to reduce generation of inferior display.

Further, in accordance with the manufacturing method of the liquid crystal display according to the above-mentioned exemplary embodiment, since the alignment layer material of high viscosity is coated on the peripheral part, it is possible to prevent properly the alignment layer material from flowing into areas other than the alignment layer material coated area on the substrate and to form the alignment layer material with certainty within the preset area.

Further, in accordance with the manufacturing device of the liquid crystal display according to the above-mentioned exemplary embodiment, since the alignment layer material is coated on the substrate by using the discharger, it is possible to coat properly a preset amount of the alignment layer material on the preset area accurately and easily. Further, since the preset amount of the alignment layer material can be coated on the preset area, even in case of using a substrate of a large area, the alignment layer material can be used properly without waste.

Further, in accordance with the liquid crystal display according to the above-mentioned exemplary embodiment, since the alignment layer of an even layer pressure is formed by means of the manufacturing method of the liquid crystal display according to the above-mentioned exemplary embodiment, it is possible to prevent the generation of inferior display properly.

Further, in accordance with the electronic equipment according to the above-mentioned exemplary embodiment, since it is mounted with a liquid crystal display manufactured in accordance with the manufacturing method of the liquid crystal display according to the above-mentioned exemplary embodiment, it is possible to improve yield of the electronic equipment. Furthermore, because the discharger is employed, it is possible to reduce the amount of the alignment layer material used, so that the manufacturing cost of the electronic equipment itself can be reduced, thereby bringing about lower cost of the electronic equipment.

Moreover, in the manufacturing device of the liquid crystal display according to the above-mentioned embodiment, a 2 mm peripheral area of the alignment layer material coated area on the substrate is set as the peripheral part. Nonetheless, any area such as a 1 mm peripheral area or a 5 mm peripheral area may be set as the peripheral part.

Namely, an area to be the peripheral part is freely set based on the type of alignment layer material, solvent composition, the solvent composition ratio and the like, and other areas may be set as the central part. Further, the alignment layer material coated area may be divided into three areas of the peripheral part, an intermediate part, and the central part.

Further, in the manufacturing device of the liquid crystal display according to the above-mentioned embodiment, the viscosity of the alignment layer material is set as 10 mPa·s and 6 mPa·s. However, based on the type of alignment layer material and the like, the alignment layer material may be adjusted for any viscosity over a range of about 5 mPa·s to 15 mPa·s and coated.

1. A manufacturing method of a liquid crystal display having a liquid crystal layer held between a pair of substrates, comprising:
discharging a liquid droplet including an alignment layer material onto the substrates; and
drying the alignment layer material and forming the alignment layer, the alignment layer material of differing viscosity being coated per preset area on the substrate by using a liquid droplet discharge device.

2. The manufacturing method of the liquid crystal display according to claim 1,
the preset area to be coated on the substrate being divided into a periphery and a central area surrounded by the periphery, so that an alignment layer material of a higher viscosity than an alignment layer material coated on the central area is coated on the periphery.

3. The manufacturing method of the liquid crystal display having a liquid crystal layer held between a pair of substrates, comprising:
a liquid droplet discharge device that discharges a liquid droplet including an alignment layer material to be coated on the substrate; and
a dryer that dries the alignment layer material coated on the substrate by the liquid droplet discharge device and that forms the alignment layer, the alignment layer material of differing viscosity being coated per preset area on the substrate by discharging the liquid droplet including the alignment layer material per preset area on the substrate through the liquid droplet discharge device.

4. A manufacturing device of the liquid crystal display according to claim 3, dividing the preset area on the substrate onto which to discharge the liquid droplet, including the alignment layer material into the periphery and the central area surrounded by the periphery, so that the alignment layer material of a higher viscosity than the alignment layer material coated on the central area is coated on the periphery.

5. A liquid crystal display that is manufactured by the manufacturing method of the liquid crystal display according to claim 1.

6. Electronic equipment, that is mounted with the liquid crystal display according to claim 5.
